(19) United States
(12) Patent Application Publication
(10) Pub. No.: US 2006/0132699 A1
(43) Pub. Date: Jun. 22, 2006

(54) Cooling apparatus and liquid crystal display device having the same

(76) Inventors: Joo-woan Cho, Seoul (KR); Chun-ho Song, Seoul (KR); Seock -hwan Kang, Suwon-si (KR); Gi-cherl Kim, Yongin-si (KR); Se-ki Park, Suwon-si (KR); Sang-gil Lee, Seoul (KR); Jong-seo Lee, Hwaseong-si (KR); Sang-yu Lee, Yongin-si (KR); Ju-young Yoon, Suwon-si (KR)

Correspondence Address: CANTOR COLBURN, LLP, 55 GRIFFIN ROAD SOUTH, BLOOMFIELD, CT, 06002, US

(21) Appl. No.: 11/313,151

(22) Filed: Dec. 20, 2005

(30) Foreign Application Priority Data
Dec. 20, 2004 (KR) 2004-0108831

(51) Int. Cl. G02F 1/1333

(52) U.S. Cl. 349/161

(57) ABSTRACT

A cooling apparatus comprises a casing, a heat sink and a cooling fan. The casing comprises a first opening and a second opening to provide an air path. The heat sink is received in the casing. The heat sink includes a recession part. The cooling fan is disposed in the recession part.

This application claims priority to Korean Patent Application No.2004-0108831, filed on Dec. 20, 2004 and all the benefits accruing therefrom under 35 U.S.C § 119, and the contents of which in its entirety are herein incorporated by reference.

### BACKGROUND OF THE INVENTION

1. Field of the Invention

The present invention relates to a cooling apparatus and a liquid crystal display device having the same.

2. Description of the Related Art

Recently, there has been a demand for replacement of conventional CRT (cathode ray tube) display devices with flat panel display devices such as, for example, LCD (liquid crystal display) devices, PDP (plasma display panel) devices, or OLED (organic light emitting diode) devices.

An LCD device comprises a liquid crystal panel having a thin film transistor board, a color filter board, and liquid crystal interposed between the thin film transistor board and the color filter board. The LCD device further comprises a chassis accommodating the liquid crystal panel and the backlight unit.

Since the LCD device is a non-light emitting device, the LCD device needs a backlight unit disposed proximate to the liquid crystal panel to supply light to the liquid crystal panel. An amount of transmission of the light provided to the liquid crystal panel by the backlight unit is controlled according to an array state of the liquid crystal.

The backlight unit is classified as either an edge type backlight or a direct type backlight according to a position of a light source. The edge type backlight has a structure in which the light source is disposed proximate to a sidewall of a light guide plate. The edge type backlight is applied to relatively small LCD devices, which are generally used in laptop and desktop computers. The edge type backlight is advantageous for having high uniformity of luminance, long lifetime, thin thickness and light weight.

The direct type backlight has been developed in response to a market tendency toward an increase in a size of LCD devices. The direct type backlight has a structure in which light is transmitted to an entire surface of the liquid crystal panel by at least one light source disposed under the liquid crystal panel. Thus, the direct type backlight achieves a high brightness by using several light sources, but may suffer from low uniformity of luminance.

Furthermore, the backlight unit, especially the direct type backlight unit using several light sources, generates a large amount of heat that lowers brightness and causes color shifts. Thus it is desirable to provide an apparatus to remove heat generated by the backlight unit.

### SUMMARY OF THE INVENTION

Accordingly, it is an aspect of the present invention to provide a cooling apparatus having a good cooling efficiency. Another aspect of the present invention is to provide a liquid crystal display device having an effectively cooled backlight unit.

Additional aspects and/or advantages of the present invention will be set forth in part in the description which follows and, in part, will be obvious from the description, or may be learned by practice of the present invention.

The foregoing and/or other aspects of the present invention are also achieved by providing a cooling apparatus comprising a casing, a heat sink and a cooling fan. The casing comprises a first opening and a second opening to provide an air path. The heat sink is received in the casing and includes a recession part. The cooling fan is disposed in the recession part.

The foregoing and/or other aspects of the present invention are also achieved by providing a display device comprising a liquid crystal panel, a backlight unit, a chassis and a cooling apparatus. The backlight unit is disposed at a back surface of the liquid crystal panel and supplies light to the liquid crystal panel. The chassis receives the liquid crystal panel and the backlight unit. The cooling apparatus is disposed in contact with the chassis. The cooling apparatus comprises a heat sink and a cooling fan. The heat sink includes a recession part. The cooling fan is disposed in the recession part. The casing includes a first opening and a second opening forming an air path through the heat sink.

The foregoing and/or other aspects of the present invention are also achieved by providing a cooling apparatus comprising a casing having a first opening and a second opening to form an air path, a heat sink received in the casing, and a cooling fan received in the casing.

The foregoing and/or other aspects of the present invention are also achieved by providing a display device comprising a liquid crystal panel, a backlight unit, a chassis, and a cooling apparatus. The backlight unit is disposed at a back surface of the liquid crystal panel and supplies light to the liquid crystal panel. The chassis receives the backlight unit and the liquid crystal panel. The cooling apparatus is disposed at an external surface of the chassis corresponding to a position of the backlight unit. The cooling apparatus comprises a casing having a first opening and a second opening to form an air path through the casing and a cooling fan received in the casing.

The foregoing and/or other aspects of the present invention are also achieved by providing a cooling method of a display device comprising a backlight unit, and a casing disposed at an external surface of the chassis corresponding to a position of the backlight unit and comprising a first opening and a second opening. The method comprises disposing a cooling fan in the first opening and operating the cooling fan to form an air path between the first opening and the second opening.

The foregoing and/or other aspects of the present invention are also achieved by providing an assembly method of a cooling apparatus comprising a casing having a first opening and a second opening forming an air path and a cooling fan. The method comprising disposing the cooling in the first opening such that the cooling fan does not protrude from the casing.

### BRIEF DESCRIPTION OF THE DRAWINGS

The above and/or other aspects and advantages of the present invention will become apparent and more readily appreciated from the following description of exemplary embodiments, taken in conjunction with the accompanying drawings in which:

FIGS. 1A and 1B are perspective views of a front surface and a back surface, respectively, of a liquid crystal display device according to an exemplary embodiment of the present invention;

FIG. 2 is a sectional view of the liquid crystal display device of FIGS. 1A and 1B;

FIG. 3 is a perspective view of a cooling apparatus according to an exemplary embodiment of the present invention;

FIG. 4 is an exploded assembly view of the cooling apparatus of FIG. 3;

FIG. 5 is a partially cut away perspective view of a cooling apparatus according to an exemplary embodiment of the present invention;

FIG. 6 is a perspective view of a cooling apparatus according to another exemplary embodiment of the present invention;

FIG. 7A is a perspective view of a liquid crystal display device according to an exemplary embodiment of the present invention;

FIG. 7B is a perspective view of a liquid crystal display device according to another exemplary embodiment of the present invention; and

FIG. 7C is a perspective view of a liquid crystal display device according to yet another exemplary embodiment of the present invention.

### DETAILED DESCRIPTION OF THE INVENTION

Reference will now be made in detail to exemplary embodiments of the present invention, which are illustrated in the accompanying drawings, wherein like reference numerals refer to like elements throughout.

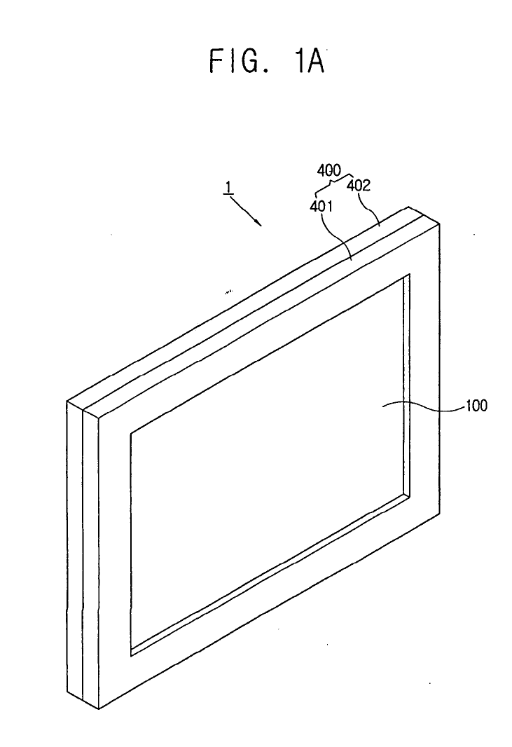

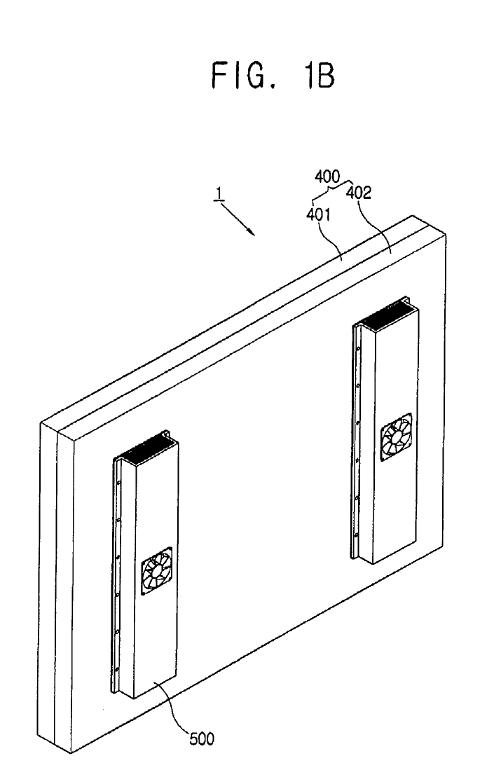

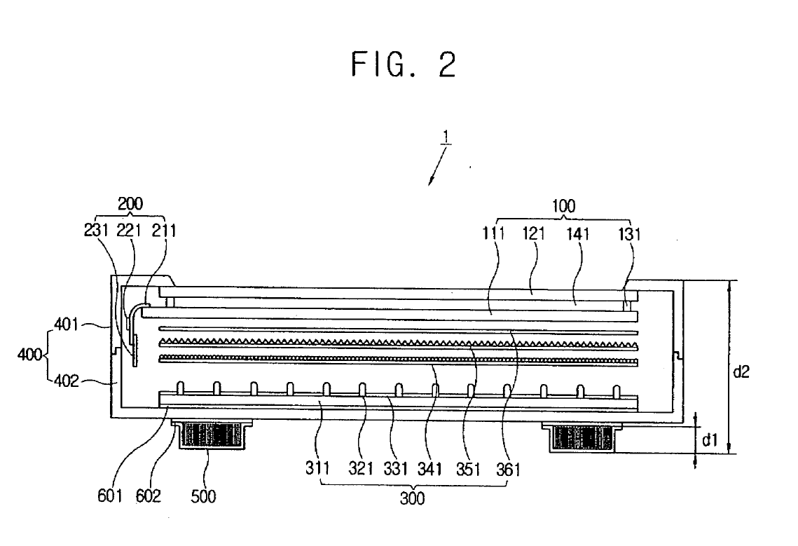

FIGS. 1A and 1B are perspective views of a front surface and a back surface, respectively, of a liquid crystal display device according to an exemplary embodiment of the present invention. FIG. 2 is a sectional view of the liquid crystal display device of FIGS. 1A and 1B.

Referring to FIGS. 1A, 1B and 2, a liquid crystal display device 1 comprises a liquid crystal panel 100, a driving part 200 applying a driving signal to the liquid crystal panel 100, a backlight unit 300 supplying light to the liquid crystal panel 100, a chassis 400 receiving the liquid crystal panel 100 and a cooling apparatus 500 disposed at an exterior surface of the chassis 400 and cooling the backlight unit 300.

The liquid crystal panel 100 comprises a thin film transistor substrate 111 having thin film transistors, a color filter substrate 121 facing the thin film transistor substrate 111, a sealant 131 bonding edge portions of the color filter substrate 121 and the thin film transistor substrate 111, and a liquid crystal layer 141 disposed between the color filter substrate 121 and the thin film transistor substrate 111 in a space defined by the sealant 131. The liquid crystal panel 100 displays images by controlling an alignment of liquid crystal molecules of the liquid crystal layer 141. Because the liquid crystal panel 100 is a non-light emitting device, the backlight unit 300 provides light to the liquid crystal panel 100.

The driving part 200 comprises a flexible print circuit (FPC) substrate 211 having a first side is connected with the thin film transistor substrate 111, a driving chip 221 provided to the FPC substrate 211, and a circuit board 231 connected with a second side of the FPC substrate 211. The driving part 200 shown in FIG. 2 is an example of a chip of film (COF) method of mounting the driving part 200. However, other well known methods include, for example, a tape carrier package (TCP) and a chip on glass (COG), etc. Alternatively, the driving part 200 may be mounted on the thin film transistor board 111.

The backlight unit 300 is a direct type backlight unit and comprises an LED circuit substrate 311 disposed parallel to the liquid crystal panel 100, an LED 321 coupled to the LED circuit substrate 311, a reflection substrate 331 reflecting light from the LED 321 toward a direction of the liquid crystal panel 100, a diffusion film 341 disposed between the LED 321 and the liquid crystal panel 100, a prism film 351, and a protecting film 361.

The LED circuit substrate 311 drives the LED 321, and at a same time, transfers heat generated by the LED 321 to the cooling apparatus 500. An upper gap pad 601 is disposed between the LED circuit substrate 311 and the chassis 400. The upper gap pad 601 prevents air from existing between the LED circuit substrate 311 and the chassis 400. Air has a low heat transfer coefficient, thus if air exists between the LED circuit substrate 311 and the chassis 400, the heat generated from the LED 321 is not effectively transferred to the cooling apparatus 500. The upper gap pad 601 is a thin board comprising a material having a high heat transfer coefficient. The LED circuit substrate 311, the upper gap pad 601, and the chassis 400 are closely adhered with each other.

The backlight unit 300 may include an array of LEDs disposed on the LED circuit substrate 311. Each LED 321 of the array of LEDs may emit, for example, a red light, a green light, or a blue light to supply a white light to the liquid crystal panel 100. The array of the LEDs is not limited to the red, green and blue lights. The LED 321 is commonly used as a light source due to the LED 321 having good color reproduction properties and good brightness.

Although in this exemplary embodiment, the LED 321 is used as the light source of the backlight unit 300, other light sources such as, for example, a cold cathode fluorescent lamp (CCFL) and an external electrode fluorescent lamp (EEFL), etc. may be used for the light source of the backlight unit 300.

The reflection substrate 331 guides the light generated by the LED 321 by reflecting the light toward the liquid crystal panel 100. The reflection substrate 331 is disposed proximate to an entire surface of the LED circuit substrate 311 except for positions at which each LED 321 of the array of LEDs are disposed.

The diffusion film 341 comprises a base board and a coating layer including bead shaped members formed on the base board. If light from the LED 321 is directly supplied to the liquid crystal panel 100, the array of the LEDs is recognizable by a user and a brightness of a display of the liquid crystal display device 1 becomes non-uniform. To prevent the above-mentioned problem, the diffusion film 341 diffuses light from each LED 321 of the array of LEDs equally, and supplies the light to the liquid crystal panel 100. The diffusion film 341 may include, for example, two sheets, or three sheets overlapped.

The prism film 351 is formed by disposing a series of linearly extended prisms at a base film. Each of the prisms has a shape of a triangular pillar and is extended parallel to each other at a regular interval. The prism film 351 concentrates light diffused by the diffusion film 341 in a vertical direction toward the liquid crystal panel 100. The prism film may include two sheets, and has a predetermined angle with a micro prism formed in the prism film 351. A majority portion of light passing through the prism film 351 passes vertically to produce a uniform brightness distribution.

The protection film 361 is disposed proximate to a surface of the prism film that faces the liquid crystal display panel 100. The protection film 361 protects the prism film 351 from scratching.

The chassis 400 includes an upper chassis 401 and a lower chassis 402, and receives the liquid crystal panel 100 and the backlight unit 300.

The cooling apparatus 500 is attached to an exterior surface of the lower chassis 402. It should be noted that any number of the cooling apparatuses 500 may be employed. Thus, although FIGS. 1B and 2 show two cooling apparatuses 500, more or less may be employed. The backlight unit 300 and the cooling apparatus 500 are disposed facing each other on opposite sides of the lower chassis 402. A lower gap pad 602 is disposed between the cooling apparatus 500 and the lower chassis 402. The cooling apparatus 500, the upper and lower gap pads 601 and 602, and the lower chassis 402 are closely adhered to each other.

The cooling apparatus 500 according to an exemplary embodiment of the present invention is described below.

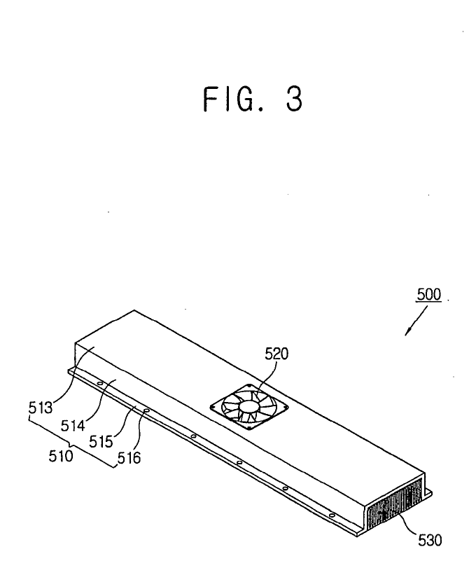

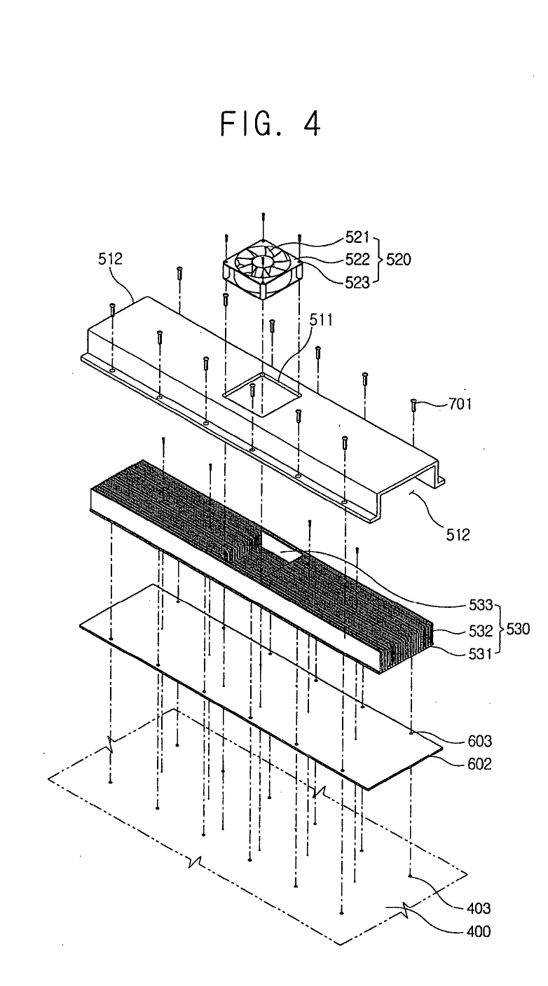

FIG. 3 is a perspective view of the cooling apparatus according to an exemplary embodiment of the present invention, and FIG. 4 is an exploded assembly view of the cooling apparatus of FIG. 3.

The cooling apparatus 500 comprises a casing 510, a cooling fan 520 and a heat sink 530 accommodated in the casing 510.

The casing 510 is shaped like a hexahedron that is open at a side of the casing 510 that faces the chassis 400 and at sides of the casing 510 disposed at longitudinal ends of the casing 510. The casing 510 may be made from a steel plate or plastic, and is preferably made of an aluminum plate.

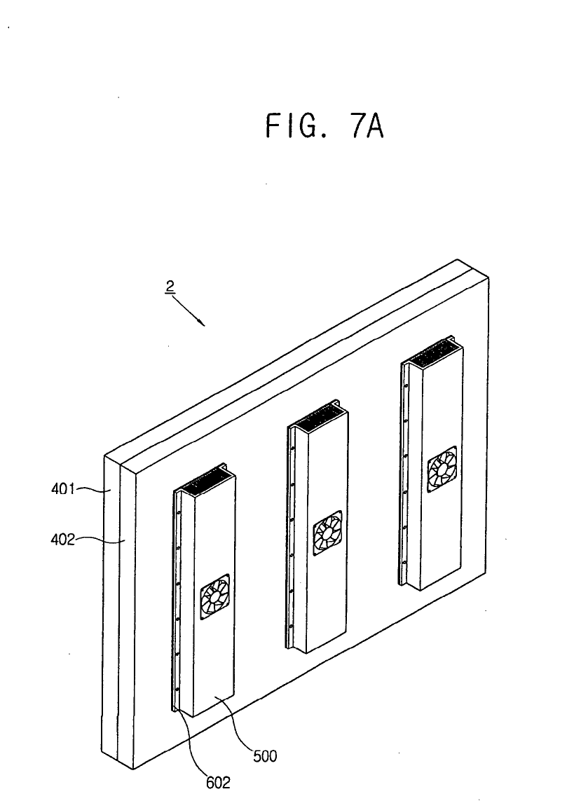

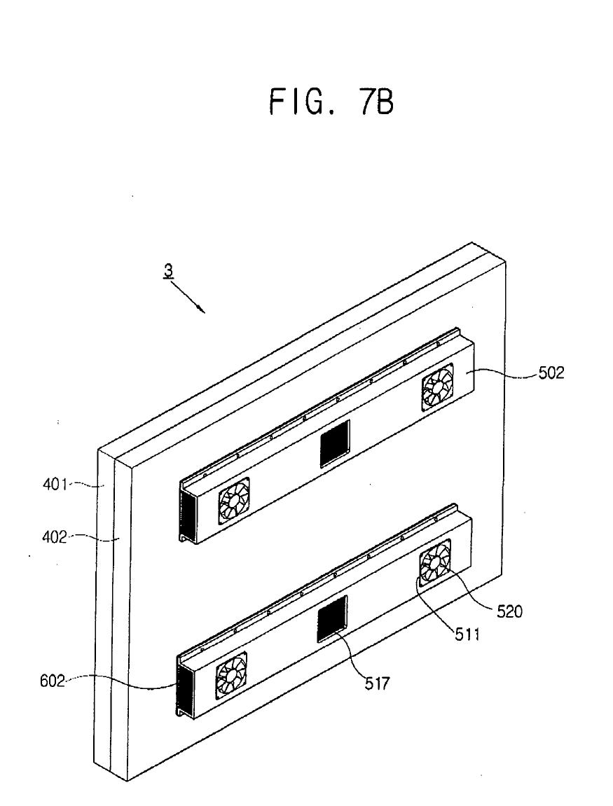

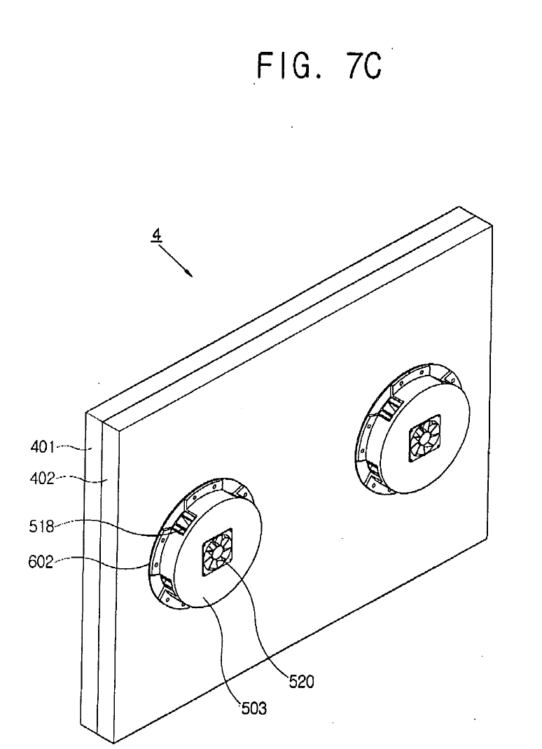

The casing 510 includes an upper plate 513, side surface parts 514, and a combination part 515. The upper plate 513 is disposed parallel to the external surface of the lower chassis 402 and the heat sink 530 is interposed between the upper plate 513 and the external surface of the lower chassis 402. The side surface parts 514 extend toward the external surface of the lower chassis 402 from opposite edges of the upper plate 513 to create a receiving space to receive the heat sink 530. The side surface parts 514 each extend substantially perpendicular to both the upper plate 513 and the external surface of the lower chassis 402. The combination part 515 extends from an edge of each of the side surface parts that is proximate to the external surface of the lower chassis 402 in a direction substantially parallel to the external surface of the lower chassis 402. The combination part 515 includes combination holes 516 disposed at intervals along a longitudinal length of the combination part 515. The combination holes 516 are aligned with contact holes 403 of the lower chassis 402 to permit attachment of the casing 510 to the lower chassis 402 via a combination screw 701. The upper plate 513, the side surface parts 514, and the combination part 515 are preferably formed integrally by a sheet metal working or an injection molding. It should be noted that although the upper plate 513 is shown to have a rectangular shape, other shapes are possible including, for example, a circle shape (see FIG. 7C).

A first opening 511 having a rectangular shape is disposed in a center portion of the upper plate 513 to allow an introduction of air to the heat sink 530. Opened ends of the casing 510 each form a second opening 512 to allow an outflow of air. Air introduced at the first opening 511 cools down the backlight unit 300 and is then discharged at the second opening 512.

The cooling fan 520 is received in the casing 510, and disposed in the first opening 511 . Air is introduced through the first opening 511 by operation of the cooling fan 520 and discharged through the second opening 512. The cooling fan 520 comprises a fan body 521 and a fan casing 522. The fan casing 522 includes a combination hole 523 to fix the cooling fan 520 to the heat sink 530. The cooling fan 520 exhausts air introduced from outside the cooling apparatus 500 to a side direction through the heat sink 530. The cooling fan 520 further comprises a power connecting wire (not shown) to be supplied with power.

The heat sink 530 comprises a heat transmission plate 531 disposed parallel to the upper plate 513, fins 532 connected to the heat transmission plate 531, and is provided with a combination hole (not shown) to permit combining the heat sink 530 with the chassis 400. A recession part 533 is disposed at a portion of the heat sink 530. The recession part 533 is disposed in a position at which the cooling fan 520 is provided. In other words, the recession part 533 corresponds with the first opening 511. The fins 532 disposed in the recession part 533 are lower than the other fins disposed in other parts of the heat sink 530. The lower gap pad 602 is disposed between the heat transmission plate 531 and the lower chassis 402. Each of the fins 532 is extended substantially perpendicular to a surface of the heat transmission plate 531 and parallel to each other along a longitudinal length of the casing 510. In other words, each of the fins 532 is disposed parallel to a direction from the first opening 511 to the second opening 512. Heat from the LED 321 transmitted to the heat transmission plate 531 is transmitted to each of the fins 532. Since a surface area of the fins 532 in contact with air is very wide, the fins 532 have good heat transmission efficiency.

The heat transmission plate 531, the lower gap pad 602, and the lower chassis 402 are closely adhered to each other. The lower gap pad 602 includes through holes 603. The combination screw 701 combines the casing 510 to chassis 400 via the combination holes 516, the through holes 603 and the contact holes 403 sequentially.

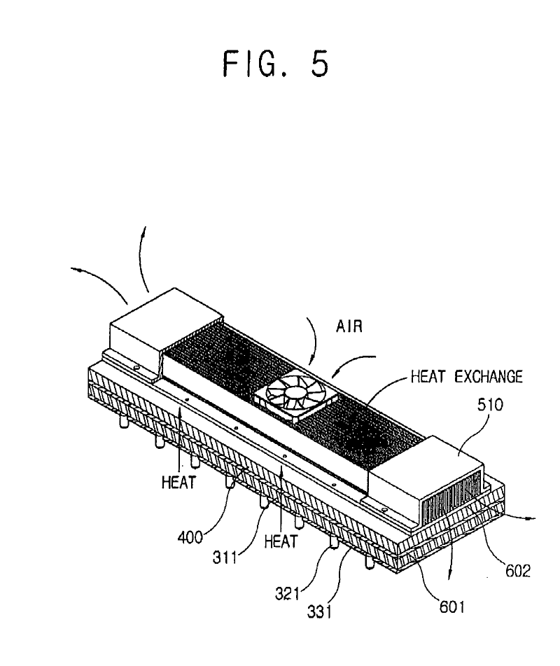

Herein below, an operation of a cooling apparatus will be described by referring to FIG. 5. FIG. 5 is a partially cut away perspective view of a cooling apparatus according to an exemplary embodiment of the present invention.

During operation of the liquid crystal display device 1, heat is generated by the LED 321 and the cooling fan 520 operates.

The heat generated by the LED 321 is transmitted to the heat transmission plate 531 of the heat sink 530 through the LED circuit substrate 321, the upper gap pad 601, the chassis 400, and the lower gap pad 602. The LED circuit substrate 321, the upper gap pad 601, the chassis 400, and the lower gap pad 602 are closely attached to each other so that heat transmission may be accomplished effectively. Thus, even heat generated by parts, which do not contact the cooling apparatus 500 directly is transmitted to the cooling apparatus 500. The heat transmitted to the heat transmission plate 531 is transmitted to the fins 532 having a wide surface area.

By operation of the cooling fan 520, air is introduced into the heat sink 530 through the first opening 511. The introduced air flows along an air path formed by the casing 510 and the heat sink 530 and discharges through the second opening 512. The fins 532 are disposed parallel to the air path, which is the direction from the first opening 511 and the second opening 512. While air flows without being disturbed, the air absorbs heat from the fins 532. Thus, the air path may be formed from the second opening 512 to the first opening 511 in accordance with an operating direction of the cooling fan 520.

The cooling apparatus 500 according to exemplary embodiments of the present invention removes the heat generated by the LED 321 by operating the cooling fan 520 and the heat sink 530. Meanwhile, referring to FIG. 2, as the cooling fan 520 of the cooling apparatus 500 is received in the casing 510, a thickness d1 of the cooling apparatus 500 is constant. A thickness d2 of the liquid crystal display device 1 attached with the cooling apparatus 500 is not increased by attaching the cooling fan 520.

Although, the cooling apparatus 500 shown is applied to the liquid crystal display device 1, the cooling apparatus 500 may be used to eliminate heat from other heat generating apparatuses, especially a flat panel display device such as a PDP (plasma display panel) or an OLED (organic light emitting diode).

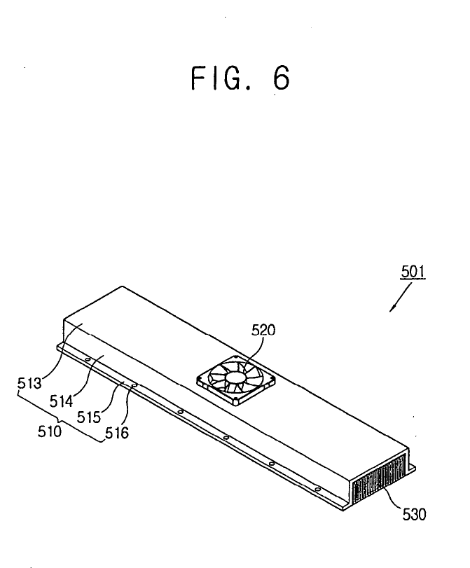

FIG. 6 is a perspective view of a cooling apparatus 501 according to another exemplary embodiment of the present invention. A structure of the cooling apparatus 501 of this exemplary embodiment is substantially similar to a structure described above referring to FIG. 3, therefore only differences in the structure of the cooling apparatus 501 will be discussed. An upper portion of the cooling fan 520 is projected outside of the casing 510. Meanwhile, a considerable portion of the cooling fan 520 is disposed inside of the casing 510. Thus a height of the cooling apparatus 501 is only slightly increased.

FIGS. 7A through 7C are perspective views of liquid crystal display devices according to alternative exemplary embodiments of the present invention.

A liquid crystal display device 2 according to an exemplary embodiment shown in FIG. 7A comprises three cooling apparatuses 500. Each of the three cooling apparatuses 500 is disposed at the lower chassis 402 such that they are substantially parallel to each other and substantially perpendicular to a longitudinal direction of the liquid crystal display device 2. A number and an installed position of the cooling apparatuses 500 is variable according to a size of the liquid crystal display device 2 and an amount of heat generated by the backlight unit 300.

A liquid crystal display device 3 according to another exemplary embodiment is shown in FIG. 7B. In this exemplary embodiment, cooling apparatuses 502 are disposed at the lower chassis 402 such that they are substantially parallel to each other and substantially parallel to a longitudinal direction of the liquid crystal display device 3. Additionally, each of the cooling apparatuses 502 includes two first openings 511 and two cooling fans 520 disposed near opposite ends of the cooling apparatuses 502. A second opening 517 is disposed at a center of each of the cooling apparatuses 502 to exhaust air coming from both directions toward the second opening 517.

A cooling apparatus 503 of a liquid crystal display device 4 according to yet another exemplary embodiment is shown in FIG. 7C. The cooling apparatus 503 is shaped like a cylinder. The cooling fan 520 is disposed at a center portion of the cooling apparatus 503 and second openings 518 are provided along edges of the cooling apparatus 503. Since air current is generated uniformly in all directions by operating the cooling fan 520, the air current may be fully utilized by shaping the cooling apparatus 503 as the cylinder of the present exemplary embodiment.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cooling apparatus comprising:
a casing comprising a first opening and a second opening to provide an air path;
a heat sink that is received in the casing, the heat sink including a recession part; and
a cooling fan disposed in the recession part.

2. The cooling apparatus according to claim 1, wherein the casing further comprises;
an upper plate part including the first opening;
a side part extended and bent from the upper plate part; and
a combination part extended and bent from the side part to be substantially parallel to the upper plate part.

3. The cooling apparatus according to claim 2, wherein the combination part comprises a combination hole.

4. The cooling apparatus according to claim 2, wherein the upper plate part is shaped like a rectangle.

5. The cooling apparatus according to claim 2, wherein the upper plate part is shaped like a circle.

6. The cooling apparatus according to claim 2, wherein the casing is integrally formed.

7. The cooling apparatus according to claim 2, wherein the heat sink further comprises:
a heat transmission plate disposed substantially parallel to the upper plate part; and
a fin connected to the heat transmission plate.

8. The cooling apparatus according to claim 7, wherein the fin extends from the heat transmission plate to a first height at a first portion of the fin and a second height at a second portion of the fin, the first height being less than the second height, and the first portion of the fin forming a portion of the recession part.

9. A display device comprising;
a liquid crystal panel;
a backlight unit disposed at a back surface of the liquid crystal panel and supplying light to the liquid crystal panel;
a chassis receiving the liquid crystal panel and the backlight unit; and
a cooling apparatus disposed in contact with the chassis, the cooling apparatus comprising a casing, a heat sink and a cooling fan, the heat sink including a recession part, the cooling fan disposed in the recession part, and the casing including a first opening and a second opening forming an air path through the heat sink.

10. The display device according to claim 9, wherein the cooling fan is disposed in the first opening.

11. The display device according to claim 10, wherein the first opening is an inlet to introduce air, and the second opening is an outlet to discharge air.

12. The display device according to claim 9, wherein the heat sink comprises;
a heat transmission plate disposed substantially parallel to the chassis; and
a fin connected to the heat transmission plate.

13. The display device according to claim 12, further comprising a lower gap pad disposed between the chassis and the heat transmission plate, wherein the chassis, the lower gap pad and the heat transmission plate are closely adhered to each other.

14. The display device according to claim 12, wherein the fin is disposed substantially parallel to a direction extended from the first opening to the second opening.

15. The display device according to claim 12, wherein the fin extends from the heat transmission plate to a first height at a first portion of the fin and a second height at a second portion of the fin, the first height being less than the second height, and the first portion of the fin forming a portion of the recession part.

16. The display device according to claim 9, wherein the backlight unit comprises light emitting diodes (LEDs).

17. The display device according to claim 16, wherein the LEDs are disposed at uniform intervals facing the back surface of the liquid crystal panel.

18. The display device according to claim 16, further comprising an LED circuit substrate disposed substantially parallel to the liquid crystal panel and coupled with the LEDs, and an upper gap pad disposed between the LED circuit substrate and the chassis and wherein the LED circuit substrate, the upper gap pad, and the chassis are closely adhered to each other.

19. The display device according to claim 9, wherein a thickness of the cooling apparatus is substantially constant.

20. The display device according to claim 9, wherein the casing comprises;
an upper plate part disposed substantially parallel to the liquid crystal panel and formed having the first opening;
a side part extended and bent from the upper plate part; and
a combination part extended and bent from the side part, and disposed substantially parallel to the upper plate part.

21. The display device according to claim 20, wherein the combination part comprises a combination hole to enable attachment of the casing to the chassis.

22. The display device according to claim 20, wherein the upper plate part is shaped like a rectangle.

23. The display device according to claim 20, wherein the upper plate part is shaped like a circle.

24. The display device according to claim 20, wherein the casing is integrally formed.

25. A cooling apparatus comprising;
a casing comprising a first opening and a second opening to form an air path;
a heat sink received in the casing; and
a cooling fan received in the casing.

26. A display device comprising;
a liquid crystal panel;
a backlight unit disposed at a back surface of the liquid crystal panel and supplying light to the liquid crystal panel;
a chassis receiving the backlight unit and the liquid crystal panel; and
a cooling apparatus disposed at an external surface of the chassis corresponding to a position of the backlight unit, the cooling apparatus comprising a casing having a first opening and a second opening to form an air path and a cooling fan received in the casing.

27. A method of cooling a display device comprising a backlight unit disposed in a chassis and a casing disposed at an external surface of the chassis corresponding to a position of the backlight unit and comprising a first opening and a second opening, the method comprising:
disposing a cooling fan in the first opening; and
operating the cooling fan to form an air path between the first opening and the second opening.

28. The method of claim 27, wherein the air path is defined by the casing and a plurality of fins are disposed in the air path substantially parallel to a direction of a current of air.

29. An assembly method of a cooling apparatus including a casing having a first opening and a second opening forming an air path through the casing, and a cooling fan, the method comprising:
disposing the cooling fan in the first opening such that the cooling fan does not protrude from the casing.

30. The method of claim 29, further comprising:
providing a heat sink received in the casing; and
combining the cooling fan with the heat sink.
